(19) United States
(12) Patent Application Publication
(10) Pub. No.: US 2020/0215764 A1
(43) Pub. Date: Jul. 9, 2020

(54) METHOD FOR ATTACHING WATER-REPELLENT FILTER TO INLET OR OUTLET OF AIR VENT FORMED IN THERMOPLASTIC RESIN MOLDED ARTICLE, THERMALLY PROCESSING TIP AND THERMALLY WELDING TIP FOR MOLDING FILTER ATTACHMENT PORTION AND FOR ATTACHING FILTER, AND MOLDED ARTICLE

(71) Applicants: MUNEKATA INDUSTRIAL MACHINERY Co., Ltd., Fukushima (JP); W. L. GORE & ASSOCIATES, CO., LTD, Tokyo (JP)

(72) Inventors: Toshihiko SAITO, Fukushima (JP); Hiroshi MANABE, Tokyo (JP)

(21) Appl. No.: 16/819,887

(22) Filed: Mar. 16, 2020

Related U.S. Application Data
(62) Division of application No. 15/316,950, filed on Dec. 7, 2016.

(30) Foreign Application Priority Data
Dec. 2, 2014 (JP) 2014-244031

(51) Int. Cl. B29C 65/20; B29C 65/38; B29C 65/00; B29C 65/18; B29C 65/30; B29C 43/18; B29C 65/56; B29C 65/72; B01D 63/08

(52) U.S. Cl. CPC B29C 65/20; B29K 2101/12; B29C 66/0222; B29C 65/18; B29C 66/71; B29C 66/30326; B29C 66/91935; B29C 66/12441; B29C 66/73116; B29C 66/91933; B29C 66/81427; B29C 66/81811; B29C 66/8181; B29C 66/81431; B29C 65/30; B29C 66/24221; B29C 43/18; B29C 66/0242; B29C 66/73175; B29C 66/5346; B29C 66/3494; B29C 66/7392; B29C 65/568; B29C 66/712; B29C 66/326; B29C 66/919; B29C 66/727; B29C 66/12469; B29C 66/8322; B29C 65/72; B01D 63/087; B29C 66/0342; B29C 66/53425; B29C 66/91212; B01D 2279/35; B29C 66/91651; B29C 66/961; B01D 2313/04; B01D 2313/56; B29C 65/38

(57) ABSTRACT

A method attaches a liquid-repellent filter to an air vent of a resin molded article accommodating a component/electronic part. A thermal processing tip and a thermally welding tip and a molded article are provided. The thermal processing tip (22) forms a filter attachment surface (14) at the inlet or outlet of an air vent (16) in a thermoplastic resin molded article (13). A filter fixing rib (15) is formed around the attachment surface. The porous filter (18) is dropped onto the filter attachment surface, and a thermal welding tip (2) is used to melt the filter fixing rib such that the melted resin flows onto and covers a circumferential edge portion of the filter, penetrating the body of the filter. The melted resin penetrating the filter 18 and covering the circumferential edge portion of the filter are cooled to solid, whereby the filter is fixed to the filter attachment surface.

### CROSS REFERENCE TO RELATED APPLICATIONS

This application is a divisional under 37 CFR 1.53(b) of pending prior U.S. application Ser. No. 15/316,950 filed Dec. 7, 2016 and claims the benefit (35 U.S.C. § 120 and 365(c)) of PCT/JP2015/074558 filed Aug. 25, 2015, which designated inter alia the United States and which claims the priority of Japanese patent application number 2014-244031 filed Dec. 2, 2014, the entire contents of each application are incorporated herein by reference.

### TECHNICAL FIELD

The present invention relates to a method for attaching a filter having water repellency with ensured air ventilation to an inlet or an outlet of an air vent formed in a thermoplastic resin molded article, a thermal processing tip and a thermally welding tip used in the attaching method, and a molded article.

### BACKGROUND

In recent years, as the functionality of a mobile phone and an electronic part for an automobile advances, these parts are accommodated in thermoplastic resin cases.

The case is provided with an air vent that allows communication between the interior of the case and the outside air so that the electronic part is not adversely affected by a change in temperature and a change in atmospheric pressure.

However, the air vent with no protection may allow rain water to enter the case through the air vent, resulting in a problem in some cases. To avoid the problem, a filter that ensures air ventilation but prevents entry of rain water is attached to the air vent.

Further, since the case is strongly required to be compact and lightweight, the filter to be used is increasingly made thinner year by year.

From the viewpoints described above, as a method for attaching a filter to an air vent provided in a case, Japanese Patent Laid-Open No. 2006-231139 discloses a thermally welding method including forming a recess in a thermoplastic resin molded article by using a heated plate, bringing a filter into the recess, and fixing the filter.

Further, as a method for welding a filter for filtering ink to a thermoplastic resin molded article, Japanese Patent Laid-Open No. 08-118672 discloses a method including providing a filter fixing portion with a plurality of fixing ribs, fixing an outer circumferential portion of the filter to the filter fixing portion, and further swaging the welding ribs to surround and fix the outer circumference of the filter.

Further, as a method for welding and fixing a water-repellent filter to a waterproofing resin product, Japanese Patent Laid-Open No. 11-111381 discloses a thermally caulking method including providing the circumference of the water-repellent filter with a thermally caulking rib, thermally deforming the rib in such a way that the rib is rounded inward and stacked on a circumferential edge portion of the water-repellent filter, and simultaneously using a welding hone to weld and fix the circumferential edge portion of the water-repellent filter to a water-repellent filter attachment portion.

### SUMMARY OF THE INVENTION

In the method disclosed in Japanese Patent Laid-Open No. 2006-231139 described above, however, the filter is fixed to the recess formed by a heated plate, but an outer circumferential portion of the filter remains unfixed. Therefore, when the filter is used, the unfixed outer edge portion is lifted up and broken or peeled off in some cases. Caution is therefore undesirably required in work using the filter.

In the method disclosed in Japanese Patent Laid-Open No. 08-118672 described above, a welding head is used to fix the filter with the double convex welding ribs and the filter outer circumference is fixed by swaging (turning down) the outer circumferential rib. In this case, however, the height of the filter changes as the front ends of the convex welding ribs are thermally deformed, resulting in wrinkles produced over the surface of the filter and along the outer circumference of the filter. Further, three welding apparatus, a welding apparatus, a swaging apparatus, and a rib-crashing, flat-finishing apparatus, are required, undesirably causing an increase in the number of steps and positional shift at the time of transition from each of the steps to another.

In the method disclosed in Japanese Patent Laid-Open No. 11-111381 described above, since the outer circumferential rib is deformed and covers the outer circumferential edge of the filter, there is no concern about the peeling off or separation of an outer edge portion, unlike in the Japanese Patent Laid-Open No. 2006-231139. However, since the method includes thermally deforming the outer circumferential rib in such a way that the rib is rounded inward and stacked on the circumferential edge portion of the water-repellent filter and simultaneously using a welding hone to weld the circumferential edge portion of the water-repellent filter to the water-repellent filter attachment portion, the filter needs to have rigidity (thickness) to some extent. Therefore, in a case where the filter is made of a soft material or has a small film thickness (fluorine-based porous membrane having thickness of 0.3 mm or smaller, in particular, 0.1 mm or smaller), positional shift and wrinkles easily occur, resulting in insufficient water tightness in some cases.

Further, in this case, since it is assumed that the filter itself has meltability in the first place, the method cannot be applied to a filter made of a material having no meltability or a filter having a melting point higher than that of a molded article to which the filter is attached.

The present invention relates to a filter that is attached to an air vent in a thermoplastic resin molded article and particularly has a film thickness of 0.3 mm or smaller and is hence soft, for example, a filter that has no firm body and is hence flimsy, a filter that is prone to adhering to almost everything due to static electricity, or filters having any other undesirable physical properties, and an object of the present invention is to provide a filter attaching method that allows a filter to be precisely fixed to a filter attachment portion with no positional shift or wrinkle and prevents the filter from peeling off over time, a thermal processing tip for forming a filter attachment portion and a thermally welding tip for attaching a filter that allow efficient filter attachment, and a molded article with a filter attached to an inlet or an outlet of an air vent.

To achieve the object described above, the invention described relates to a method for attaching a filter to an air vent, characterized in that the method includes: a. forming a filter fixing rib around an inlet or an outlet of an air vent formed in a thermoplastic resin molded article; b. then dropping a filer inside the filter fixing rib; c. then heating and melting the filter fixing rib to cause the melted resin to flow onto a circumferential edge of the filter and cover the circumferential edge of the filter and to penetrate the filter body at the same time; and d. then cooling the resin covering the circumferential edge of the filter and penetrating the filter body to allow the resin to solidify so that the filter is fixed to an inlet or outlet portion of the air vent.

The invention may be further characterized in that in the filter attaching method, the air vent includes a sound hole.

The invention may be further characterized in that in the filter attaching method described, the filter has a ventilation property and a liquid-repellency property.

The invention may be further characterized in that in the filter attaching method described, the filter has a gap or a minute hole through which the melted resin penetrates the filter.

The invention may be further characterized in that in the filter attaching method described, the filter has a thickness ranging from 30 to 300 μm.

The invention may be further characterized in that in the filter attaching method described, the filter is made of a fluorine-based porous resin.

The invention may be further characterized in that in the filter attaching method described, the filter has a melting point higher than a melting point of a molded article to which the filter is attached.

The invention may be further characterized in that in the filter attaching method described, a surface of a filter drop portion surrounded by the fixing rib is lower than, flush with, or higher than a surface of the molded article.

The invention may be further characterized in that in the filter attaching method described, the filter fixing rib formed in the molded article is molded integrally with the molded article when the molded article is molded.

The invention may be further characterized in that in the filter attaching method described, the filter has a circular or polygonal contour.

The invention further relates to a filter attachment portion forming method including heating and melting a front end of a thermal processing tip while causing the front end to sink into a circumferential edge portion of an inlet or an outlet of an air vent formed in a thermoplastic resin molded article to form a filter attachment surface at an inlet or outlet portion of the air vent in such a way that the filter attachment surface is lower than the inlet or outlet portion and raise the melted resin around the inlet or outlet portion by the sinking so as to form a filter attachment portion in the inlet or outlet portion of the air vent of the molded article, a filter fixing rib being formed in the inlet or outlet portion.

The invention further relates to a thermal processing tip for forming a filter attachment portion, characterized in that the thermal processing tip is formed by forming a center rib to be inserted into an inlet or an outlet of an air vent formed in a thermoplastic resin molded article, the center rib formed at a center of a front end surface of a tip main body, forming a heat generating surface around a base of the center rib, further forming a vertical wall surface in a vertical direction from a periphery of the heat generating surface, and further forming a positioning flange in a position recessed from the vertical wall surface.

The invention further relates to a thermally welding tip for attaching a filter, characterized in that the thermally welding tip is formed by forming a thermally processing rib on a front end surface of a tip main body, forming a gate rib in a periphery of the front end surface with an amount of protrusion of the gate rib smaller than an amount of protrusion of the thermally processing rib, and forming a heat generating press surface between the gate rib and the thermally processing rib.

The invention may be further characterized in that the thermal processing tip described or the thermally welding tip is based on an impulse heating method, namely comprises an impulse heater element.

The may further relate to a thermoplastic resin molded article characterized in that a filter having a water-repellency property and a ventilation property is attached to an inlet or an outlet of an air vent of the thermoplastic resin molded article based on a melted resin penetration effect.

According to the method aspects of the invention, a filter is dropped into a stepped portion formed at an inlet or an outlet of an air vent, a filter fixing rib is melted, the melted resin is caused to flow onto and cover a circumferential edge portion of the filter in the stepped portion and penetrate a body of the filter at the same time, and then the melted resin is so cooled as to solidify to fix the filter in the stepped portion.

As a result, no wrinkle or gap is produced when the filter is attached because no particular load is applied to the filter, whereby the filter is securely fixed with no concern about entry of rain water via the circumference edge portion of the filter.

Further, the filter is attached to the filter attachment portion formed with the thermal processing tip described by using the thermally welding tip described in claim, and this allows formation of the filter attachment portion at the inlet or the outlet of the air vent of the thermoplastic resin molded article and an increase in efficiency in the work of attaching the filter to the attachment portion.

Further, according to the invention, since the attached filter does not protrude into the space around the inlet or the outlet of the air vent, there is no concern about breakage of the filter due to contact with a hand or another part.

Further, according to the invention, since the melted resin covers the circumferential edge portion of the filter, the circumferential edge of the filter is fixed throughout the entire circumference. As a result, a situation in which separation occurs at the circumferential edge of the filter can be avoided.

Next, according to another aspect of the invention, the present invention is also directed to a sound hole formed in a thermoplastic resin molded article.

Next, according to another aspect of the invention, the present invention is directed to a filter having a ventilation property and a liquid-repellency property.

Next, according to another aspect of the invention, the filter is fixed with further increased strength resulting from solidification of the penetrated resin.

Next, according to another aspect of the invention, the present invention is also directed to a very thin filter.

Next, according to another aspect of the invention, a filter having a ventilation property and a liquid-repellency property and readily allowing penetration of melted resin can be formed.

Next, according to another aspect of the invention, the filter can be attached to the air vent of the resin molded article in a single step.

Next, according to another aspect of the invention, the filter can be set in a correct position.

Next, according to another aspect of the invention, formation of the filter fixing rib in a molded article requires no specific step, whereby the productivity is improved and the cost can be reduced.

Next, according to another aspect of the invention, the filter can be selected and used in accordance with the shape of the air vent.

Next, according to another aspect of the invention, the filter attachment portion can be processed in a production site in accordance with the size of the filter.

Next, to another aspect of the invention, the filter attachment portion can be readily formed in one-touch operation.

Next, according to another aspect of the invention, since the filter can be readily attached, and the gate rib formed around the heat generating press surface comes into contact with the thermoplastic resin molded article as the thermal processing tip descends, a situation in which the melted resin extends off toward the outer circumference of the resin article is avoided, and the outer edge portion of the filter can be reliably fixed.

Next, according to another aspect of the invention, the tip can be efficiently heated and readily controlled.

Next, according to another aspect of the invention, since the filter is reliably attached to the air vent, a reliably molded article can be provided.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view showing a thermoplastic resin molded article having an air vent to which a filter is attached;

FIG. 2 is an enlarged view of a filter attachment portion of FIG. 1;

FIG. 3 is a perspective exterior view of a thermal processing tip for attaching the filter to the air vent;

FIG. 4 is a cross-sectional view of the thermal processing tip for attaching the filter to the air vent according to a first embodiment, the filter, and the air vent of the resin molded article;

FIG. 5a is a cross-sectional view in a case where a filter attachment surface is flush with a surface of the thermoplastic resin molded article;

FIG. 5b is a cross-sectional view in a case where the filter attachment surface is higher than the surface of the thermoplastic resin molded article;

FIG. 6a is a view of one of filter attaching steps of the method of for installing a filter on an inlet or outlet of a ventilation hole formed on a thermoplastic resin molded article;

FIG. 6b is a view of another of filter attaching steps of the method of for installing a filter on an inlet or outlet of a ventilation hole formed on a thermoplastic resin molded article;

FIG. 6c is a view of another of filter attaching steps of the method of for installing a filter on an inlet or outlet of a ventilation hole formed on a thermoplastic resin molded article;

FIG. 6d is a view of another of filter attaching steps of the method of for installing a filter on an inlet or outlet of a ventilation hole formed on a thermoplastic resin molded article;

FIG. 6e is a view of another of filter attaching steps of the method of for installing a filter on an inlet or outlet of a ventilation hole formed on a thermoplastic resin molded article;

FIG. 6f is a view of another of filter attaching steps of the method of for installing a filter on an inlet or outlet of a ventilation hole formed on a thermoplastic resin molded article;

FIG. 7 is an exterior view of a thermal processing tip for forming a filter attachment portion;

FIG. 8 is a cross-sectional view of the thermal processing tip for forming a filter attachment portion and an air vent of a resin molded article;

FIG. 9a is a view of a step of the method for forming the filter attachment portion wherein the ventilation hole includes an acoustic hole;

FIG. 9b is a view of another step of the method for forming the filter attachment portion wherein the ventilation hole includes an acoustic hole;

FIG. 9c is a view of another step of the method for forming the filter attachment portion wherein the ventilation hole includes an acoustic hole;

FIG. 9d is a view of another step of the method for forming the filter attachment portion wherein the ventilation hole includes an acoustic hole;

FIG. 9e is a view of another step of the method for forming the filter attachment portion wherein the ventilation hole includes an acoustic hole;

FIG. 10a is a view showing attachment of a filter to a plurality of air vents; and

FIG. 10b is a view showing another attachment of a filter to a plurality of air vents.

### DESCRIPTION OF EMBODIMENTS

Referring to the drawings, in the present invention, two types of a thermally welding tip will be described: One is a thermally welding tip used to form a filter attachment portion that allows a filter to be attached to an inlet or an outlet of an air vent provided in a thermoplastic resin molded article; and the other is a thermally welding tip used to attach a filter to the formed attachment portion.

### Embodiments

A first embodiment of the present invention relates to a filter attaching method described in claim 1, a thermal processing tip and a thermally welding tip used to carry out the method and described in claims 12 and 13, respectively.

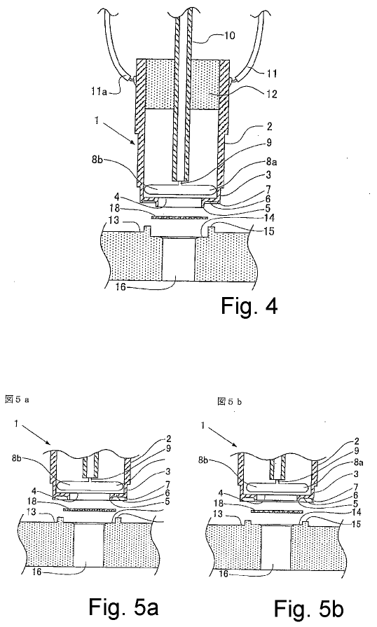

A thermally welding tip for filter attachment will first be described with reference to FIGS. 3 and 4. A thermal processing tip 2 of a thermally welding apparatus 1 has a heat generating press surface 6 so formed at a front end 3 of the tip 2 as to surround a clearance hole 4. A ring-shaped thermally processing rib 5 is so provided as to protrude from the inner side of the heat generating press surface 6, and a gate rib 7 is so provided as to protrude from the outer circumferential edge of the heat generating press surface 6.

The thermally processing rib 5 is higher than the gate rib 7 by 0.5 mm (or an arbitrary dimension according to the shape of the thermally processing rib in a case where the height difference is greater than or equal to 0.1 mm).

Reference characters 8 and 8a denote cooling air flow-out windows formed on the side having the rear of the heat generating press surface 6 and in symmetric positions. Reference characters 9 and 9a denote slits 15 formed on opposite side surfaces of the thermal processing tip 2 and in symmetric positions. Reference character 10 denotes a cooling air pipe. Reference characters 11 and 11a denote lead wires for voltage application. Reference character 12 denotes an insulator. Reference character 13 denotes a thermoplastic resin molded article. Reference character 14 denotes a filter attachment surface. Reference character 15 denotes a filter fixing rib. Reference character 16 denotes an air vent formed in the thermoplastic resin molded article 13. Reference character 17 denotes cooling air blown through the cooling air pipe 10. Reference character 18 denotes a water-repellent filter to be attached.

Providing the clearance hole 4 at the center of the front end of the thermal processing tip 2 prevents heat produced by the heat generating press surface 6 from affecting the filter 18.

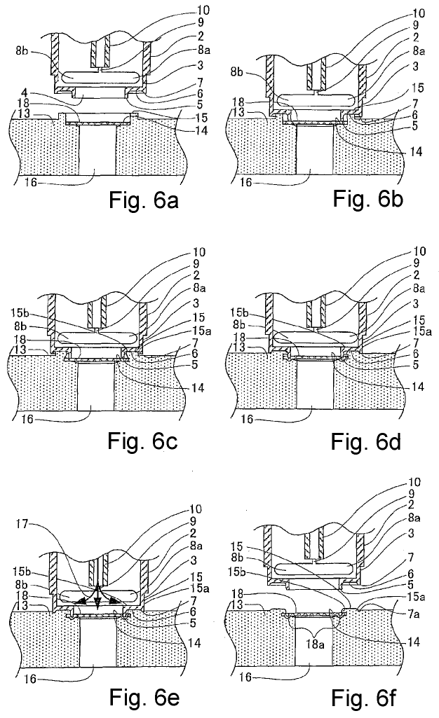

In FIG. 4, in which the filter attachment surface 14 is formed at the inlet or the outlet of the air vent 16 of the thermoplastic resin molded article 13, and the filter fixing rib 15 is formed around the filter attachment surface 14, the filter 18 is dropped to and set at the filter attachment surface 14 manually or by using an automatic loader, as shown in FIG. 6a.

The filter 18 in the present first embodiment is a porous membrane made of a fluorine resin (PTFE) with t=0.1 mm and φ=11.0 mm.

The thermally processing rib 5 of the thermal processing tip 2 has an outer diameter φ of 10.0 mm and an inner diameter φ of 9.0 mm. The gate rib 7 of the thermal processing tip 2 has an outer diameter φ of 17.0 mm. The step between the front end of the thermally processing rib 5 and the heat generating press surface 6 has a dimension of 0.8 mm. The step between the front end of the thermally processing rib 5 and the front end of the gate rib 7 has a dimension of 0.5 mm.

The thermoplastic resin molded article 13, to which the filter 18 is welded, is made of an ABS resin and provided with the air vent 16 having a diameter φ of 4.0 mm.

A method for attaching the filter 18 will next be described with reference to FIGS. 6a to 6f.

FIG. 6a shows a state in which the filter 18 is dropped on the filter attachment surface 14, which is formed at the inlet of the air vent 16 of the thermoplastic resin molded article 13, and the thermal processing tip 2 of the thermally processing apparatus 1 is moved to a position above the filter 18 and is ready for processing.

FIG. 6b shows a state in which the thermal processing tip 2 descends to a point where the heat generating press surface 6 of the thermal processing tip 2 comes into contact with the filter fixing rib 15 and a front end portion of the thermally processing rib 5 comes into contact with the filter 18 at the same time. At this point, when a power supply (not shown) applies voltage to the lead wires 11 and 11a, the heat generating press surface 6, which is formed at the front end of the thermally welding tip 2, generates heat due to the electric resistance of the heat generating press surface 6.

The temperature to which the thermally welding tip 2 is heated is controlled by the power supply, and it is further effective to perform feedback control using a thermocouple (not shown) attached to the front end of the thermally welding tip 2.

The temperature to which the thermally welding tip 2 is heated can be set as appropriate by selection of the materials of the filter 18 and the thermoplastic resin molded article 13, but the temperature to which the thermally welding tip 2 is heated needs to be higher than the melting point of the thermoplastic resin molded article 13 by at least 50° C. but lower than the melting point of the filter 18.

In the first embodiment, the material of the thermoplastic resin molded article 13 is an ABS resin having a melting point of 110° C. The filter 18 is made of a porous polytetrafluoroethylene having a melting point of 327° C. The temperature to which the thermally welding tip 2 is heated is 260° C.

At the same time, the thermally welding tip 2 is pressed at an appropriate pressure by a drive apparatus that is not shown against the molded article 13.

The filter fixing rib 15 heated by and pressed against the heat generating press surface 6 of the thermally welding tip 2 starts melting from above and spreads rightward and leftward along the heat generating press surface 6, and the thermally welding tip 2 further descends accordingly, as shown in FIG. 6c.

The thermally processing rib 5 of the thermally welding tip 2 having descended then comes into contact with the filter 18, as shown in FIG. 6d. The thermally processing rib 5 heats the periphery of the filter 18 while pressing the filter 18.

In this process, when the thermally processing rib 5 descends (lowers), the thermally processing rib 5 gives the filter 18 force that widens the filter 18 from the center thereof toward the outer circumference thereof, whereby the filter 18 does not wrinkle.

The thermally processing rib 5 causes the filter 18 to lower onto the filter attachment surface 14 of the thermoplastic resin molded article 13 while deforming the filter 18 in a concave shape, and the melted resin of the thermally processing rib 5 penetrates the body of the filter 18 at the same time.

At this point, the filter fixing rib 15 having been heated and having therefore melted spreads rightward and leftward along the heat generating press surface 6 but does not reach the circumferential edge of the filter 18.

When the thermally welding tip 2 further descends, the melted resin reaches from an outer portion 15a of the filter fixing rib 15 to the gate rib 7 but is blocked by the gate rib 7 because the front end of the gate rib 7 is in contact with the thermoplastic resin molded article 13, as shown in FIG. 6e. The melted resin thus does not flow out of the gate rib 7.

An inner portion 15b of the melted filter fixing rib 15 therefore flows downward along the thermally processing rib 5 and eventually covers a circumferential edge portion of the filter 18.

The position to which the thermally welding tip 2 descends is set in advance. In the present first embodiment, the descent position is set at a position where the thermally processing rib 5 comes into contact with the top of the filter 18 having a certain thickness (0.1 mm) and the thickness is reduced by one-half (0.05 mm).

Further, in the descent position, a state in which the gate rib 7 intrudes into the thermoplastic resin molded article 13 by 0.3 mm is achieved. As a result, a situation in which the outer portion 15a of the melted filter fixing rib 15 extends off is avoided, and a front end 20 of the gate rib 7 forms a parting groove 7a having a depth of 0.3 mm around the filter attachment surface 14 at the same time, whereby post-process exterior appearance is improved (see FIGS. 6e and 6f).

Setting the volume (cross-sectional area) of the filter fixing rib 15 in such a way that the post-process volume is smaller than the pre-process volume allows the filter fixing rib 15 melted in the position to which the thermally welding tip 2 descends to be pressurized between the thermally processing rib 5 and the gate rib 7, whereby the melted resin penetrates the filter 18. The ratio of the post-process volume of the filter fixing rib 15 to the pre-process volume thereof is selected as appropriate and ranges from 90 to 99%. The ratio is set at 95% in the present first embodiment.

FIG. 2 shows a state in which the melted resin penetrates the filter 18 and covers the circumferential edge of the filter 18.

After a preset heating period elapses with the thermally welding tip 2 in the set descent position, the voltage application is terminated, and cooling air 17 is supplied through the cooling air pipe 10 provided as part of the thermally welding tip 2 at the same time, as shown in FIG. 6e. Therefore, the cooling air 17 is blown to the rear side of the heat generating press surface 6, and the pressure of the blown air internally cools the front end 3 of the thermally welding tip 2 including the heat generating press surface 6 of the thermal processing tip 2.

The cooling air 17 is then discharged out of the thermally welding tip 2 through the flow-out windows 8 and 8a and the slits 9 and 9a.

As described above, cooling the front end 3 of the thermally welding tip 2 for a period set in advance allows the thermally processing rib 5, the heat generating press surface 6, and the gate rib 7 to be cooled, and the outer portion 15a and the inner portion 15b of the melted filter fixing rib 15 solidify. Further, resin 18a penetrating the filter 18 is cooled and solidifies, and the solidification of the penetrated resin more securely fixes the filter 18 to the thermoplastic resin molded article 13.

Thereafter, the supply of the cooling air 17 is terminated, and the thermally welding tip 2 is so lifted as to be separate above from the filter 18.

As a result, the filter 18 is fixed to the inlet of the air vent 16 of the thermoplastic resin molded article 13, as shown in FIG. 6f.

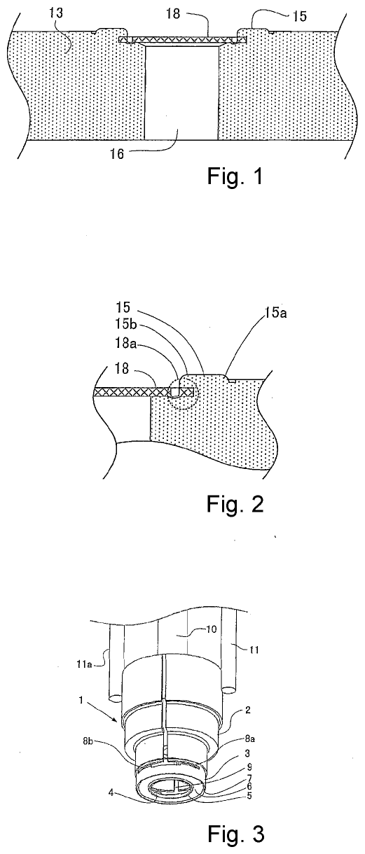

FIG. 1 is a cross-sectional view after the filter is attached.

In the present embodiment, the filter attachment surface 14 is lower than a surface of the thermoplastic resin molded article 13, as shown in FIG. 5a. The filter can be attached in the same manner also in a case where the filter attachment surface 14 is flush with the surface of the thermoplastic resin molded article 13, as shown in FIG. 5a, or a case where the filter attachment surface 14 is higher than the surface of the thermoplastic resin molded article 13, as shown in FIG. 5b.

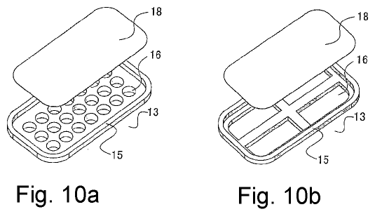

Further, each of the shape of the filter 18 and the shape of the air vent 16 of the filter attachment portion is not limited to a circular shape, and the present invention can be implemented in a case where each of the shapes is a polygonal shape. The invention can still further be implemented in a case where a plurality of air vents 16 are present, as shown in FIG. 10a, and in a case where each air vent 16 has a roughly rectangular shape and a cross-shaped beam is present, as shown in FIG. 10b. As clearly seen in the examples described above, the present invention can be applied to air vents 16 and filters 18 having a variety of shapes.

A second embodiment of the present invention relates to a thermal processing tip for forming a filter attachment portion described in claim 12 and a method for forming the filter attachment portion by using the tip.

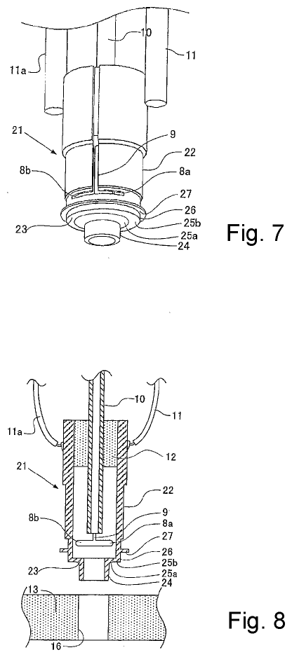

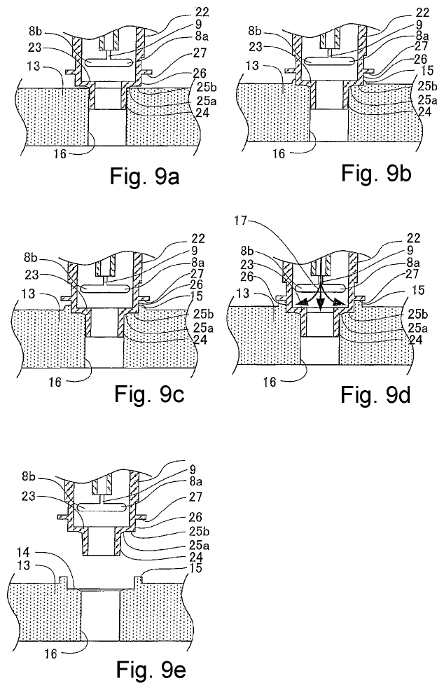

FIGS. 7 and 8 show the structure of the thermal processing tip, and FIGS. 9a to 9e show the method for forming the filter attachment portion described in claim 2.

A thermal processing tip 22 is used to form the filter attachment portion 14 and the filter fixing rib 15.

FIG. 7 is a perspective view of a thermally processing apparatus for forming the filter attachment portion. FIG. 8 is a longitudinal cross-sectional view of a central portion of the thermally processing apparatus. FIGS. 9a to 9e describe the formation method. Reference character 21 denotes the overall thermally processing apparatus, and reference character 22 denotes the thermal processing tip.

In the thermal processing tip 22, a cylindrical, centrally hollow guide portion 24 is so provided as to protrude from a heat generating surface 23 at the front end of the thermal processing tip 22, a chamfered portion 25a is formed around a portion recessed from the front end of the guide portion 24 and a filter attachment surface formation portion 25b is so formed as to follow the chamfered portion 25a, and a flange 27 is formed around the outer circumference 26 of the heat generating surface 23 and in a position recessed from the filter attachment surface formation portion 25b.

The front end of the guide portion 24 has a rounded portion having a radius of 0.3, and the outer circumference of the guide portion 24 has a 2°-tapered portion. The rounded portion and the tapered portion allow the thermal processing tip 22 to be smoothly inserted into the air vent 16 of the thermoplastic resin molded article 13 and the thermal processing tip 22 to be readily positioned.

Reference characters 8 and 8a denote cooling air flow-out windows formed in the side surface of the thermal processing tip 22 and in symmetric positions on the side facing the rear of the heat generating surface 23. Reference characters 9 and 9a denote vertically cut slits formed in the side surface of the thermal processing tip 22 and in symmetric positions. Reference character 10 denotes a cooling air pipe. Reference characters 11 and 11a denote lead wires for voltage application. Reference character 12 denotes an insulator. Reference character 13 denotes a thermoplastic resin molded article. Reference character 16 denotes an air vent formed in the thermoplastic resin molded article 13. Reference character 17 denotes cooling air blown through the cooling air pipe 10 after the thermal processing tip 22 melts and forms the filter attachment portion in FIG. 9d described above to cool the melted portion with blown cooling wind and cause the melted portion to solidify.

A method for processing the filter attachment portion will next be described with reference to FIGS. 9a to 9e.

FIG. 9a shows a state in which the guide portion 24 of the thermal processing tip 22 is inserted into the air vent 16 of the thermoplastic resin molded article 13. At this point, when a power supply (not shown) applies voltage to the lead wires 11 and 11a, the heat generating surface 23, which is formed at the front end of the thermal processing tip 22, generates heat due to the electric resistance of the heat generating surface 23.

At the same time, the thermal processing tip 22 is pressed at an appropriate pressure by a drive apparatus that is not shown against the molded product 13.

The diameter of the guide portion 24 at the base of the tapered portion thereof and at the boundary between the base and the chamfered portion 25a is equal to the diameter of the air vent 16. Further, since the guide portion 24 separates away from the heat generating surface 23 with distance toward the front end of the guide portion 24, the temperature in the guide portion 24 does not increase toward the front end thereof.

Therefore, when the melting starts, a circumferential edge portion of a rib around the air vent 16 that is in contact with the chamfered portion 25a is caused to flow toward the filter attachment surface formation portion 25b along the slope of the chamfered portion 25a. When the heating further advances, the portion in contact with the filter attachment surface formation portion 25b melts, but no resin flows toward the front end of the guide portion 24 but is caused to flow out of the filter attachment surface formation portion 25b, as shown in FIG. 9b.

No burr is therefore formed in the air vent 16, and entry of foreign matter resulting from any burr into the air vent 16 can be avoided.

When the thermal processing tip 22 further descends, the filter attachment surface formation portion 25b of the thermal processing tip 22 sinks into the surface of the molded article 13 in a portion around the inlet of the air vent 16, and the heated, melted resin is pushed out toward the outer circumference 26 and raised there, as shown in FIG. 9c. Eventually, the front end of the raised resin reaches the flange 27, as shown in FIG. 9d.

As described above, the thermal processing tip 22 having sunk into the portion around the air vent 16 melts and pushes the resin corresponding to the amount of sink outward to form the filter attachment surface formation portion 25b, and the outer circumference 26 and the flange 27 form the filter attachment portion (stepped portion to which filter is dropped) 14 and the filter fixing rib 15 at the inlet of the air vent 16.

The position to which the thermal processing tip 22 descends is set in advance. In the present second embodiment, the descent position is set at a position where the filter attachment surface formation portion 25b and the filter fixing rib 15 are formed as intended in terms of dimension.

After a heating period elapses with the thermal processing tip 22 located in the set descent position, the voltage application is terminated, and cooling air 17 is supplied through the cooling air pipe 10 provided in the thermal processing tip 22 at the same time, as shown in FIG. 9d. Therefore, the cooling air 17 is blown to the rear side of the heat generating surface 23, and the pressure of the blown air internally cools the front end of the thermal processing tip 22 including the rear side of the heat generating surface 23 of the thermal processing tip 22.

The cooling air 17 is then discharged out of the thermal processing tip 22 through the flow-out windows 8 and 8a, the slits 9 and 9a, and the hole of the guide 24.

As described above, cooling the heat generating surface 23 of the thermal processing tip 22 for a period set in advance allows the guide 24, the chamfered portion 25a, the filter attachment surface formation portion 25b, the outer circumference 26, and the flange 27 to be cooled, and the melted, raised resin solidifies into the filter fixing rib 15 having an annular shape in a plan view. Thereafter, the supply of the cooling air 17 is terminated, and the thermal processing tip 22 is lifted so that the thermal processing tip 22 is separated from the thermoplastic resin molded article 13.

As a result, the filter attachment surface 14 and the filter fixing rib 15 are formed around the inlet of the air vent 16 of the thermoplastic resin molded article 13, as shown in FIG. 9e.

The configuration of the thermal processing tip 22, which forms the filter attachment portion and the method for forming the filter attachment portion have been described.

The filter 18 is attached to the thus formed filter attachment portion by using the thermally welding tip 2 described in the first embodiment.

In the present second embodiment, the material of the thermoplastic resin molded article 13 is an ABS resin, and the temperature of the thermal processing tip 22 is set at 260° C.

FIG. 10a is a conceptual view of an example in which in a case where the molded article 13 is provided with a plurality of air vents 16, the single filter 18 covers the plurality of air vents 16 together, and the filter fixing rib 15 fixes the filter 18, and FIG. 10b is a conceptual view of an example in which air vents 16 are formed in the form of a lattice in the molded article 13.

While specific embodiments of the invention have been shown and described in detail to illustrate the application of the principles of the invention, it will be understood that the invention may be embodied otherwise without departing from such principles.

What is claimed is:

1. A method for installing a filter on an inlet or outlet of a ventilation hole formed on a thermoplastic resin molded article, the method comprising the steps of:
forming, with a thermal processing tip, a filter installation surface on the inlet or outlet of the ventilation hole formed on the thermoplastic resin molded article;
providing the thermal processing tip with a construction in which a guiding portion is formed at a center of a top of the main body of the tip, the guiding portion being inserted into the inlet or outlet of the ventilation hole formed on the thermoplastic resin molded article during the step of forming, while a pressing heating surface is formed around the base part of the guiding portion, and a flange is further formed on an outer circumference of the heating pressing surface at a position slightly set back and to form the filter installation surface using the thermal processing tip, the guiding portion is inserted into the inlet or outlet of the ventilation hole on the thermoplastic resin molded article, with the thermal processing tip being heated electrically and pressed to cause the top of the thermal processing tip to sink in the inlet or outlet of the ventilation hole, thereby melting resin around the inlet or outlet of the ventilation hole, and the top is caused to sink until the molten resin comes in contact with the flange, thereby raising a circumference of the inlet or outlet of the ventilation hole to form a filter-fastening rib to receive the filter;
providing a thermal welding tip, for fastening the filter, with a construction in which a thermal processing rib is jutted out at the center of the top surface of the thermal welding tip, and a gate rib is formed outside the thermal processing rib, thereby forming the pressing heating surface between the thermal processing rib and the gate rib;
dropping the filter on the filter installation surface formed on the inlet or outlet of the ventilation hole through use of the thermal welding tip, the thermal welding tip is heated electrically and caused to descend so that the pressing heating surface is pressed against the top of the filter-fastening rib while the filter-fastening rib is bent inward in a circular manner along the pressing heating surface and is simultaneously molten, and the molten resin covers the periphery of the filter such that the periphery is wrapped with the resin, while the top of the thermal processing rib causes the filter to bite into the surface of the filter installation surface;
and then cooling air is blown to cool and harden the molten resin.

2. The method for installing a filter according to claim 1, wherein the ventilation hole includes an acoustic hole.

3. The method for installing a filter according to claim 1, wherein the filter has a ventilation property and liquid repellency.

4. The method for installing a filter according to claim 1, wherein fine gaps or pores through which the molten resin penetrates are formed on the filter.

5. The method for installing a filter according to claim 1, wherein the filter has a thickness between 30 μm and 300 μm.

6. The method for installing a filter according to claim 1, wherein the material of the filter is a porous fluororesin.

7. The method for installing a filter according to claim 1, wherein the melting point of the filter is higher than the melting point of the molded article on which the filter is installed.

8. The method for installing a filter according to claim 1, wherein the surface of the portion surrounded by the fastening rib to receive the filter is formed a level lower than the surface of the molded article, or at the same level as the molded article, or at a level higher than the surface of the molded article.

9. The method for installing a filter according to claim 1, wherein the filter-fastening rib to be formed on the molded article is molded integrally when the molded article is molded.

10. The method for installing a filter according to claim 1, wherein the filter has a circular or polygonal outline.

11. A method for forming a filter installation portion by forming the filter installation portion on an inlet or outlet of a ventilation hole formed on a thermoplastic resin molded article, the method comprising the steps of:
causing a top of a thermal processing tip to sink in a periphery of the inlet or outlet of the ventilation hole while heating and melting the periphery, thus forming a level depressed filter installation surface on the inlet or outlet of the ventilation hole; and
simultaneously forming a filter-fastening rib by raising the molten resin through sinking of the thermal processing tip on a circumference of the inlet or outlet.

12. A method comprising the steps of:
providing a filter;
providing a thermoplastic resin molded article comprising ventilation hole;
providing a thermal processing tip comprising a thermal processing tip main body comprising a thermal processing main body end portion, a thermal processing rib on the thermal processing main body end portion, a gate rib extending circumferentially from the thermal processing main body end portion a lesser distance than that of the thermal processing rib and a pressing and heating surface between the gate rib and the thermal processing rib, the thermal processing rib defining a filter contact area of the thermal processing main body end portion for contacting a filter, the gate rib and the pressing and heating surface defining a filter free contact area of the thermal processing main body end portion for being free of contact with the filter;
providing the filter on an inlet or an outlet of the ventilation hole via the thermal processing tip.

13. The method according to claim 12, wherein the thermal processing rib defines an opening.

14. The method according to claim 13, wherein the opening is located radially inward of the thermal processing rib with respect to a longitudinal axis of the thermal processing main body.

15. The method according to claim 12, wherein the gate rib and the pressing and heating surface define article engaging contact areas configured for engaging the thermoplastic resin molded article to fix the filter to the thermoplastic resin molded article.
